(19) United States
(12) Patent Application Publication
(10) Pub. No.: US 2008/0268401 A1
(43) Pub. Date: Oct. 30, 2008

(54) Led Having Wide Wavelength-Range and Light Curing Unit Using the Same

(75) Inventor: Tae-Weon Kim, Seoul (KR)

Correspondence Address: ROTHWELL, FIGG, ERNST & MANBECK, P.C., 1425 K STREET, N.W., SUITE 800, WASHINGTON, DC, 20005, US

(73) Assignee: INVISITECH CO., LTD., Seoul (KR)

(21) Appl. No.: 11/910,957

(22) PCT Filed: Apr. 8, 2005
(86) PCT No.: PCT/KR2005/001025

§ 371 Date: Jun. 28, 2008

(51) Int. Cl. A61C 3/00

(52) U.S. Cl. 433/29

(57) ABSTRACT

The present invention provides a light-curing unit, comprising an LED having two or more light-emitting chips for emitting light in different respective wavelength ranges among wavelength ranges for curing photopolymers so that the LED emits light in a wavelength range of 400 nm to 500 nm; a power source for supplying electric power to the LED; and a housing formed to take the shape of a rod that can be introduced into the mouth of a person so as to limit the position and light-emitting direction of the LED. With the use of the LED and the light-curing unit using the same according to the present invention, there are advantages in that it is possible to cure (light cure) all photopolymers that are light curable at different wavelengths, expenses for purchase and management of equipment can be reduced, and convenience can be ensured since the LED and the light-curing unit can be used in common regardless of the kinds of photopolymers.

### TECHNICAL FIELD

The present invention relates to a light-curing unit having an LED (light-emitting device) for emitting light to activate a photo initiator contained in a photopolymer. More particularly, the present invention relates to a light-curing unit configured to emit light in a wider wavelength-range so as to cure various kinds of photopolymers of which photo initiators are activated at different wavelengths.

### BACKGROUND ART

Photopolymers are variously used as medical materials such as resins employed in the field of dental treatment or technology, cosmetic materials such as nail manicure, and the like. Since the properties and curing rates of the photopolymers can be easily controlled, the photopolymers are more widely used than chemically-curable polymers. As for apparatuses for curing photopolymers by activating photo initiators contained in the photopolymers, LED-type light-curing units are most widely used.

Typical fields in which products are manufactured by curing (light curing) a variety of photopolymers if necessary include the fields of dental treatment and technology. Light-curing units used in the dental treatment field refer to apparatuses for curing light-curable resins for use in filling in broken regions or cavities in teeth. Recently, such light-curing units have a tendency to be in gradually increasing demand.

A conventional LED employed in a conventional light-curing unit will be described below with reference to the accompanying drawings.

FIG. 1 is a front view of a conventional LED, FIG. 2 is a rear view of the LED shown in FIG. 1, and FIG. 3 is a side view of the LED shown in FIG. 1.

A shown in FIGS. 1 to 3, the conventional LED comprises a lens 10 for allowing light to be transmitted and dispersed therethrough, a plurality of light-emitting chips 12 connected to one another and installed in a repetitive pattern inside the lens 10, and a metal plate 14 with the light-emitting chips 12 attached thereto and with a large area for improving light reflection efficiency.

The LED is provided with two leads 10a through which electric power is applied to the LED, and the lens 10 is made of a transparent or translucent material so that light can be transmitted therethrough.

At this time, the lens 10 is to allow light, which has been emitted from the light-emitting chips 12, to be transmitted and dispersed therethrough. Although the lens is generally formed to have a hemispherical shape, it can be modified to have any one of various shapes such as a rectangle, a pentagon, an octagon, a circle and the like.

The light-emitting chips 12 are placed inside the lens 10, and connected to one another and installed in a repetitive pattern. The metal plate 14 has the light-emitting chips 12 attached thereon and functions to improve light reflection efficiency.

Further, a hole 18 is formed at the center of the metal plate 14. The hole 18 functions to remove air bubbles in epoxy, which are generated upon assembly of the LED, as well as to assist in dissipating heat after the assembly.

The metal plate 14 is further provided with a white coating layer 16 on a surface thereof to which the light-emitting chips 12 are attached, so that emitted light can effectively come out to the outside.

However, since the conventional LED emits only one kind of light, there is a disadvantage in that the wavelength range of the emitted light is limited to a certain range.

Dental material manufacturers that prepare light-curable resins generally have strong tendencies to prepare the light-curable resins using their own unique catalysts and to supply them to dental clinics or laboratories. Generally, the products supplied as such have been prepared to have different wavelength ranges for curing (light curing) resins of the respective products. Therefore, there is a disadvantage in that a user utilizing a light-curing unit mounted with a conventional LED should have different light-curing units respectively suitable for curing the resins of the respective manufactures in order to cure various kinds of resins.

Accordingly, there is a need for a method capable of curing all products of dental material manufacturers using only one curing unit.

### DISCLOSURE OF INVENTION

### Technical Problem

The present invention is conceived to solve the aforementioned problems in the prior art. An object of the present invention is to provide an LED and a light-curing unit using the same, wherein light in a wide wavelength range is emitted to cure (light cure) all photopolymers that undergo light curing at different wavelengths.

### Technical Solution

To achieve the object, an LED of the present invention has two or more light-emitting chips for emitting light in different respective wavelength ranges among wavelength ranges for curing photopolymers.

A light-curing unit of the present invention comprises an LED having two or more light-emitting chips for emitting light in different respective wavelength ranges among wavelength ranges for curing photopolymers; a power source for supplying electric power to the LED; and a housing for limiting the position and light-emitting direction of the LED.

At this time, the light-emitting chips employed in the present invention are mounted in such a manner that light-emitting chips for emitting light in different respective wavelength ranges are mounted close to each other, and light resulting from mixture of the light emitted from the respective light-emitting chips includes light in a wavelength range of 400 nm to 500 nm.

Further, the housing employed in the present invention is formed to take the shape of a rod that can be introduced into the mouth of a person, and has the LED coupled to a distal end thereof that is introduced into the mouth.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a front view of a conventional LED;

FIG. 2 is a rear view of the LED shown in FIG. 1;

FIG. 3 is a side view of the LED shown in FIG. 1;

FIG. 4 is an exploded perspective view of an LED according to an embodiment of the present invention;

FIG. 5 shows an LED according to another embodiment of the present invention;

FIG. 6 shows a wavelength range of a first light-emitting chip employed in the present invention;

FIG. 7 shows a wavelength range of a second light-emitting chip employed in the present invention;

FIG. 8 shows a wavelength range of a third light-emitting chip employed in the present invention;

FIG. 9 shows a wavelength range of the LED of the present invention;

FIG. 10 shows an LED with different arrangement of light-emitting chips according to a further embodiment of the present invention; and

FIG. 11 is a sectional view of a light-curing unit according to the present invention.

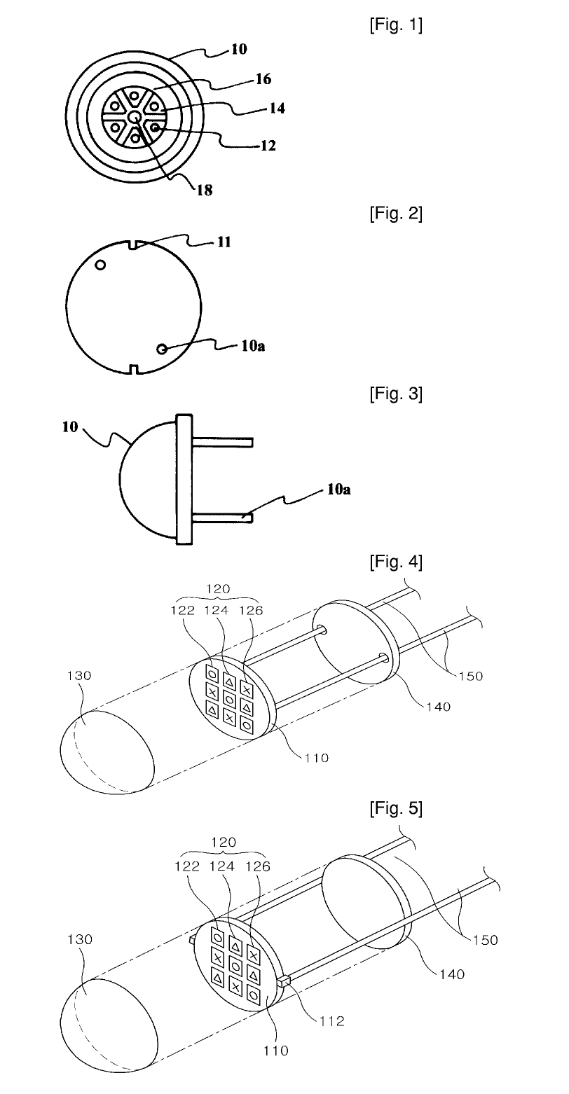

### BEST MODE FOR CARRYING OUT THE INVENTION

Hereinafter, preferred embodiments of an LED and a light-curing unit according to the present invention will be described in detail with reference to the accompanying drawings.

FIG. 4 is an exploded perspective view of an LED according to an embodiment of the present invention.

A shown in FIG. 4, the LED of this embodiment of the present invention comprises an LED substrate 110 mounted with light-emitting chips for emitting light in different respective wavelength ranges among wavelength ranges for curing photopolymers; a lens 130 made of a transparent material and coupled to the LED substrate 110 to cover the light-emitting chips 122, 124 and 126; a heat-dissipating plate 140 coupled to a rear surface of the LED substrate 110 to dissipate heat generated from the light-emitting chips 120; and leads 150 connected to the LED substrate 110 to apply an electric current to the light-emitting chips 120.

The light-emitting chips 120 comprise first light-emitting chips 122, second light-emitting chips 124 and third light-emitting chips 126, which emit light in different respective wavelength ranges. The light-emitting chips 122, 124 and 126 are arranged such that different kinds of light-emitting chips are disposed close to one another. As shown in FIG. 4, when the respective light-emitting chips 122, 124 and 126 are arranged, one first light-emitting chip 122, one second light-emitting chip 124 and one third light-emitting chip 126 are included in one row or one column. Light emitted from the LED has an even wavelength range regardless of a location where respective lights from the light-emitting chips 122, 124 and 126 are mixed.

Although three kinds of light-emitting chips 120 are mounted in a 3×3 matrix in this embodiment, the kinds and arrangement of the light-emitting chips 120 are not limited thereto but can be variously changed.

Further, each of the leads 150 for use in applying an electric current to the respective light-emitting chips 122, 124 and 126 has one end connected to the rear surface of the LED substrate 110 and the other end drawn to the outside while penetrating though the heat-dissipating plate 140.

The lens 130 is to allow the light, which has been emitted from the light-emitting chips 120, to be transmitted and dispersed therethrough. Although the lens is generally formed to have a hemispherical shape, it can be modified to have any one of various shapes such as a rectangle, a pentagon, an octagon, a circle and the like.

Since the coupling structures and performances of the lens 130 and the heat-dissipating plate 140 are identical to those of the lens 10 and the light-emitting chips 12 employed in the conventional LED, detailed descriptions thereof will be omitted.

FIG. 5 shows an LED according to another embodiment of the present invention.

The LED of the present invention can be variously changed in view of the connection structure of the leads 150 in addition to changes in the shape of the lens 130.

As shown in FIG. 5, LED substrate terminals 112 for applying an electric current to the light-emitting chips 120 are provided at both sides of the LED substrate 110, and the leads 150 are connected directly to the LED substrate terminals 112 without penetrating though the heat-dissipating plate 140. Then, there are advantages in that it is possible to eliminate a process of providing the heat-dissipating plate 140 with holes though which the leads 150 penetrate, and a contact area of the heat-dissipating plate with the LED substrate 110 is increased to improve the efficiency of the heat-dissipating plate 140.

Since the formation of the LED substrate terminals 112 and the connection of the leads 150 are similar to those in a conventional LED, detailed descriptions thereof will be omitted.

At this time, the light-emitting chips 120 are arranged such that the respective light-emitting chips 122, 124 and 126 are disposed close to light-emitting chips different from one another, in the same manner as the embodiment shown in FIG. 4.

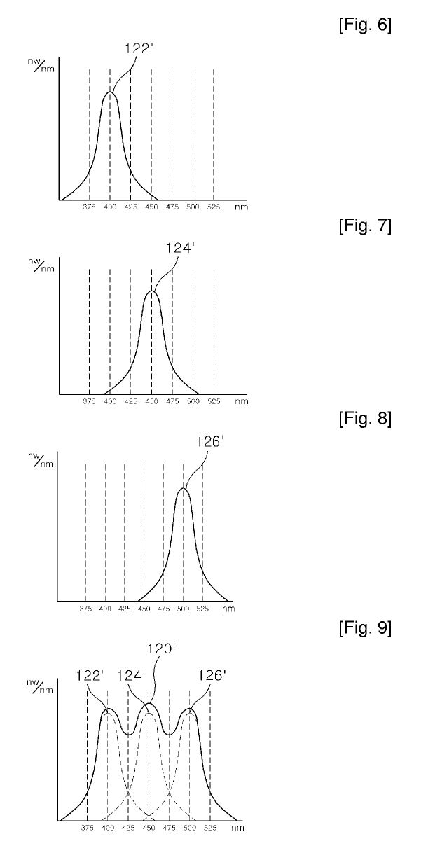

FIG. 6 shows a wavelength range of the first light-emitting chip employed in the present invention.

A graph 122′ shown in FIG. 6 shows the wavelength range and the luminous intensity of the first light-emitting chip 122, wherein the abscissa indicates the wavelength and the ordinate indicates the luminous intensity.

Since an effective wavelength range of a light-emitting chip is generally difficult to exceed 50 nm, light-emitting chips have been fabricated to emit light in various wavelength ranges according to their uses. The first light-emitting chip 122 is configured to emit light of which luminous intensity can cure a photopolymer at a wavelength of 375 nm to 425 nm.

Therefore, when only the first light-emitting chips 122 among the light-emitting chips 120 employed in the LED of the present invention are operated to emit light, only a photopolymer that can be subjected to a polymerization reaction by light with a wavelength in a range of 375 nm to 425 nm is cured, while a photopolymer that can be subjected to a polymerization reaction by light with a wavelength exceeding 425 nm is not cured. Thus, it is possible to obtain the same effects as a case where a photopolymer is cured using a conventional LED.

FIG. 7 shows a wavelength range of the second light-emitting chip employed in the present invention, and FIG. 8 shows a wavelength range of the third light-emitting chip employed in the present invention.

As shown in FIGS. 7 and 8, the second and third light-emitting chips 124 and 126 employed in the present invention are configured to emit light of which luminous intensity can cure photopolymers at wavelengths of 425 nm to 475 nm and 475 nm to 525 nm, respectively.

Therefore, when only the second light-emitting chips 124 among the light-emitting chips 120 employed in the LED of the present invention are operated to emit light, only a photopolymer that can be subjected to a polymerization reaction by light with a wavelength in a range of 425 nm to 475 nm is cured. When only the third light-emitting chips 126 are operated to emit light, only a photopolymer that can be subjected to a polymerization reaction by light with a wavelength in a range of 475 nm to 525 nm is cured.

Since the second and third light-emitting chips 124 and 126 are identical to the first light-emitting chips 122 in view of other constitutions except the wavelength range of the emitted light, detailed descriptions thereof will be omitted.

FIG. 9 shows a wavelength range of the LED of the present invention.

When all the light-emitting chips 122, 124 and 126 employed in the present invention are operated to emit light, the respective light emitted from the light-emitting chips 122, 124 and 126 are mixed with one another, so that the mixed light has the property shown as a graph 120′ in FIG. 9.

Therefore, when all the light-emitting chips 122, 124 and 126 employed in the LED of the present invention are operated to emit light, various kinds of photopolymers that can be subjected to polymerization reactions by light with a wavelength in a range of 375 nm to 525 nm are cured at one time.

Although there is a little difference among generally used photopolymers according to their manufacturers, all of them are subjected to polymerization reactions by light with a wavelength in a range of 400 nm to 500 nm. Thus, with the use of a light-curing unit of the present invention, there is an advantage in that all various kinds of photopolymers can be cured by only a single light-curing unit.

Although the respective light-curing chips 122, 124 and 126 employed in this embodiment are constructed to emit light with the wavelengths in the ranges shown in FIGS. 6 to 9 which are suitable for curing generally used photopolymers, the wavelength ranges of the light emitted from the respective light-curing chips 122, 124 and 126 are not limited thereto but can be variously changed according to users' needs.

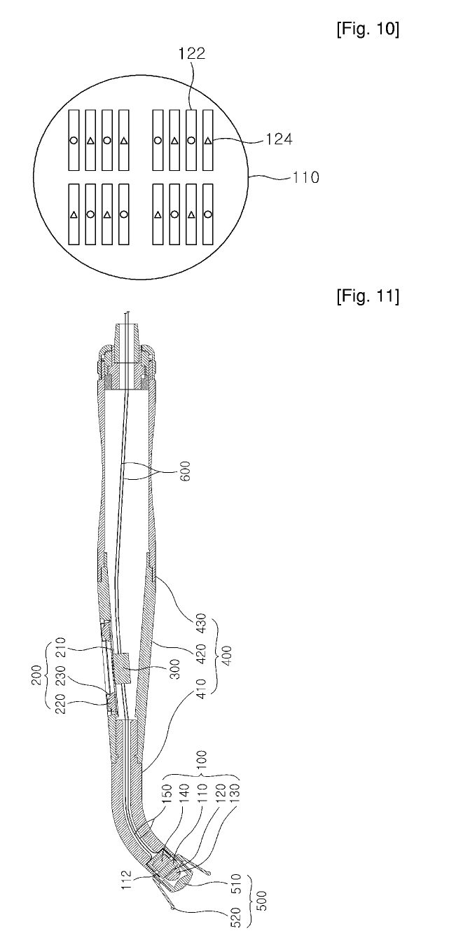

FIG. 10 shows an LED with different arrangement of light-emitting chips according to a further embodiment of the present invention.

The arrangement of the light-emitting chips 120 employed in the present invention may be changed such that the light-emitting chips can be connected as shown in FIG. 10.

In the LED of the present invention, two kinds of light-emitting chips 120 can be used as shown in FIG. 10, and four or more kinds of light-emitting chips may also be used according to users' needs.

Further, when the light-emitting chips 122 and 124 are alternately arranged at short intervals as shown in FIG. 10, the effects of mixture of light emitted from the respective light-emitting chips 122 and 124 are maximized. Thus, it is possible to obtain light with an even wavelength range regardless of connection positions of the light-emitting chips 122 and 124.

FIG. 11 is a sectional view of a light-curing unit according to the present invention.

The light-curing unit shown in FIG. 11 is a dental light-curing unit to which the LED shown in FIG. 5 is applied. The light-curing unit comprises an LED 100 mounted with two or more light-emitting chips 120 for emitting light in different wavelength ranges among wavelength ranges for curing photopolymers; an on/off operating portion 200 for generating on/off signals used in turning the LED 100 on or off; a controller 300 for controlling the on/off of the LED 100 by receiving the on/off signals generated by the on/off operating portion 200; a housing portion 400 including an LED housing 410 for limiting the position and the light-emitting direction of the LED 100, a button housing 420 for fixing the on/off operating portion 200, and a handle housing 430 serving as a handle grasped by a user; a guide portion 500 for defining the light-emitting direction of the LED 100; and a power source (not shown) for supplying electric power to the LED 100 and the controller 300.

At this time, leads 150 connected to LED substrate terminals 112 penetrate the LED housing 410 and are then connected to the controller 300, so that an electric current and a signal applied by the controller 300 are transmitted to the light-emitting chips 120. Since the constitution and operation of the LED 100 of the light-curing unit are the same as the previously mentioned LED 100, detailed descriptions thereof will be omitted.

The on/off operating portion 200 comprises a button PCB 210 connected to the controller 300 to form a circuit, a switch 220 connected to the button PCB 210 to generate the on/off signals, and a button panel 230 for fixing the position of the switch 220 while covering the switch 220 such that the switch 220 is not exposed directly to the outside.

The housing portion 400 is made in the form of a rod that can be introduced into the mouth of a person, and the LED 100 is coupled to a distal end of the housing portion, which is introduced into the mouth.

Further, the guide portion 500 comprises a guide lens 510 coupled to cover and protect the LED 100 against the external environment and made of a transparent material to allow the light emitted from the LED 100 to be transmitted to the outside; and a safety mirror 520 for limiting the radiation direction of the light to prevent the occurrence of a trouble in user's eyesight due to omnidirectional dispersion of the light emitted from the LED 100.

A power cable 600 connected to the power source (not shown) penetrates through the handle housing 430 and the button housing 420 and is then connected to the controller 300, thereby performing the application of electric power for the operations of the respective portions.

Since the constitution of the dental light-curing unit constructed as above is the same as a conventional LED type light-curing unit in view of other components except the LED, a detailed description will be omitted.

When the LED 100 of the present invention is applied to a dental light-emitting unit, various kinds of resins that have various curing (light curing) wavelength ranges according to their manufacturers can be cured. Therefore, since various kinds of resins can be cured by only a single light-curing unit without separate light-curing units according to the kinds of resins, there are advantages in that expenses can be saved and the light-curing unit can be conveniently used.

Moreover, the housing portion 400 employed in the present invention is made of a highly conductive material such as an aluminum alloy so that heat generated from the LED 100 can be transferred to the outside through the housing portion 400. When the housing portion 400 is made of a highly conductive material in such a manner, the entire housing portion 400 serves as a heat-dissipating plate so that the light-curing unit of the present invention can exhibit more improved heat-dissipating effects.

At this time, if an adhesive is used to couple the LED 100 to the housing portion 400, it is preferred that the adhesive have a good heat transfer rate such that the heat generated from the LED 100 can be more effectively transferred to the housing portion 400.

Although the present invention has been described in detail in connection with the preferred embodiments, the scope of the present invention is not limited to the specific embodiments but should be construed on the basis of the appended claims.

Particularly, although the preferred embodiments of the present invention have been described in connection with the application of the LED of the present invention to a dental light-curing unit, the use of the LED of the present invention is not limited to the dental light-curing unit but can be applied to various apparatuses.

Further, it should be understood by those skilled in the art that various modifications and changes can be made thereto without departing from the scope of the present invention.

### INDUSTRIAL APPLICABILITY

With the use of the LED and the light-curing unit using the same according to the present invention, the following advantages can be obtained: it is possible to cure (light cure) all photopolymers that are light curable at different wavelengths, expenses for purchase and management of equipment can be reduced, and convenience can be ensured since the LED and the light-curing unit can be used in common regardless of the kinds of photopolymers.

1. An LED (100), comprising:
two or more light-emitting chips (120) for emitting light in different respective wavelength ranges among wavelength ranges for curing photopolymers;
an LED substrate (110) for fixing the light-emitting chips (120);
a lens (130) made of a transparent material and coupled to the LED substrate (110) to cover the light-emitting chips (120);
a heat-dissipating plate (140) coupled to a rear surface of the LED substrate (110) to dissipate heat generated from the light-emitting chips (120) to the outside; and
leads (150) connected to the LED substrate (110) to apply an electric current to the light-emitting chips (120).

2. The LED (100) as claimed in claim 1, wherein the light-emitting chips (120) are mounted such that light-emitting chips for emitting light in different wavelength ranges are close to each other.

3. The LED (100) as claimed in claim 1, wherein the light-emitting chips (120) are configured such that light emitted from the respective light-emitting chips for emitting light in different wavelength ranges and then mixed with one another includes light in a wavelength range of 400 nm to 500 nm.

4. A light-curing unit, comprising:
an LED (100) having two or ore light-emitting chips (120) for emitting light in different respective wavelength ranges among wavelength ranges for curing photopolymers;
a power source for supplying electric power to the LED (100); and
a housing (400) for limiting the position and light-emitting direction of the LED (100).

5. The light-curing unit as claimed in claim 4, wherein the housing (400) is formed to take the shape of a rod that can be introduced into the mouth of a person, and has the LED (100) coupled to a distal end thereof that is introduced into the mouth.

6. The light-curing unit as claimed in claim 4, wherein the light-emitting chips (120) are mounted such that light-emitting chips for emitting light in different wavelength ranges are close to each other.

7. The light-curing unit as claimed in claim 4, wherein the light-emitting chips (120) are configured such that light emitted from the respective light-emitting chips for emitting light in different wavelength ranges and then mixed with one another includes light in a wavelength range of 400 nm to 500 nm.

8. The light-curing unit as claimed in claim 4, wherein the housing (400) is made of an aluminum alloy, and the LED (100) is bonded to the housing (400) by means of a thermally conductive adhesive.
